(19) United States
(12) Patent Application Publication
(10) Pub. No.: US 2017/0038743 A1
(43) Pub. Date: Feb. 9, 2017

(54) ELECTRONIC TIMEPIECE

(71) Applicant: Seiko Epson Corporation, Tokyo (JP)

(72) Inventor: Akihiro SAWADA, Matsumoto (JP)

(21) Appl. No.: 15/219,587

(22) Filed: Jul. 26, 2016

(30) Foreign Application Priority Data
Aug. 7, 2015 (JP) 2015-157307

(51) Int. Cl. G04R 20/02; G04C 10/02; G04B 19/30

(52) U.S. Cl. CPC G04R 20/02; G04B 19/30; G04C 10/02

(57) ABSTRACT

An electronic timepiece improves power generating performance and timepiece appearance. The electronic timepiece has an optically transparent dial 2; a solar panel 25 disposed on the back cover side of the dial 2 and having a power generating portion; and a planar antenna 40 disposed on the back cover side of the dial 2 and located at a position with at least part of the antenna not superimposed in plan view with the power generating portion. The dial 2 has a low transmittance area TL, and a high transmittance area TH with greater transmittance than the low transmittance area TL. The area of the dial 2 not superimposed in plan view with the power generating portion is the low transmittance area TL.

### BACKGROUND

1. Technical Field

The present invention relates to an electronic timepiece that has a solar panel and an antenna.

2. Related Art

Electronic timepieces that drive the hands, operate a signal receiver, receive microwave signals such as satellite signals, and acquire time information using power produced by a solar panel are known from the literature. See, for example, JP-A-2010-96707.

A solar cell and a GPS (Global Positioning System) antenna for receiving satellite signals are disposed on the back cover side of the dial in the electronic timepiece described in JP-A-2010-96707. To prevent signals passing through the dial from being blocked by the solar cell and not reaching the GPS antenna, the solar cell in this electronic timepiece is disposed to a position not superimposed with the GPS antenna in plan view. In another electronic timepiece described in JP-A-2010-96707, the solar cell is disposed to a position superimposed with the GPS antenna in plan view, but there are no electrodes in this part of the solar cell.

Because power consumption is high in an electronic timepiece that receives microwave signals such as satellite signals, there is a need to improve the solar conversion efficiency (performance) of the solar panel. The transmittance of the entire dial could conceivably be increased to increase the amount of light incident to the solar panel and improve efficiency. In this case, however, the portion where the solar cell is not located, and the portion where electrodes are not formed in the solar cell of the electronic timepiece in JP-A-2010-96707 can be seen by the user and detract from the appearance of the timepiece.

### SUMMARY

An objective of the present invention is to improve the solar conversion efficiency and appearance of an electronic timepiece as described in the embodiments and examples described below.

An electronic timepiece according to an aspect of the invention has an dial configured to transmit light; a solar panel disposed on the back cover side of the dial and having a power generating portion; and an antenna disposed on the back cover side of the dial and located at a position where at least part of the antenna is not superimposed in plan view with the power generating portion; the dial having a first transmittance area having a specific transmittance, and a second transmittance area having greater transmittance than the first transmittance area, and the area of the dial not superimposed in plan view with the power generating portion being the first transmittance area.

To prevent signal passing through the dial from being blocked by the solar panel and not reaching the antenna, a notch is formed, or a non-generating portion that does not function as a power generating portion and has no electrodes is formed, in the solar panel at least where the solar panel is superimposed in plan view with the antenna. As a result, the power generating portion does not overlap at least part of the antenna in plan view.

The first transmittance area is a part with transmittance making seeing the back cover side of the dial difficult from the face side of the dial; and the second transmittance area is a part where transmittance is greater transmittance than the first transmittance area, much light passes through the dial, and the transmittance can improve the power output of the power generating portion. The second transmittance area may be a single part with the same transmittance, plural areas with different transmittance, or multiple areas with the same transmittance.

In this example, the area of the dial not superimposed in plan view with the with the power generating portion is the first transmittance area.

Because the notch or non-power generating portion are superimposed in plan view with the first transmittance area, the notch and non-power generating portion are difficult to see from the face side of the dial, and the appearance of the electronic timepiece can be improved.

By having a second transmittance area, the amount of light reaching the power generating portion can be increased and the output of the solar panel can be improved compared with a configuration in which the electronic timepiece 1 only has a first transmittance area.

Preferably in an electronic timepiece according to another aspect, the solar panel has multiple solar cells; and a division line separating adjacent solar cells of the solar panel is superimposed in plan view with the first transmittance area.

The appearance of the timepiece may be adversely affected if division lines can be seen by the user, but this aspect can improve the appearance of the timepiece because division lines are difficult to see.

In an electronic timepiece according to another aspect, the solar panel has multiple solar cells; a division line separating adjacent solar cells of the solar panel has a straight segment; and the second transmittance area is superimposed in plan view with the straight segment.

Straight segments of the division lines are difficult to see through the dial.

As a result, by superimposing the second transmittance area with a straight segment of a division line, the division line can be obscured and the appearance of the electronic timepiece can be improved even if the second transmittance area is designed to overlap the division line in plan view and the second transmittance area covers the division line.

Further preferably in an electronic timepiece according to another aspect, the solar panel has multiple solar cells; and the product of the exposed area of a solar cell and the transmittance of the dial in the area corresponding to the solar cell is the same in each solar cell.

The current output of the solar panel is limited to the current output of the cell with the lowest output in the group of solar cells. By equalizing the current output of each solar cell, the current output of the solar panel can be maximized.

The current output of a solar cell is proportional to the light-receiving (exposed) area of the solar cell and the irradiance at the cell surface. Because light reaches the solar cell through the dial, the irradiance changes with the transmittance of the dial. Because the dial has a first transmittance area and a second transmittance area with transmittances, the transmittance in the part of the dial corresponding to each solar cell also differs. The exposed area is increased for a solar cell where the transmittance of the corresponding area of the dial is low, and the exposed area is decreased for a solar cell where the transmittance of the corresponding area of the dial is high. The current output of the solar cells can therefore be equalized if the product of the exposed area of the solar cell and the transmittance of the dial in the area where the light received by the solar cell passes is the same in each solar cell. The current output of the solar panel can therefore be increased. Note that equal as used herein includes substantially equal.

In an electronic timepiece according to another aspect, a subdial is disposed to the dial; and the second transmittance area is disposed in the area corresponding to the subdial.

Because the transmittance differs, the tone of the first transmittance area and the second transmittance area also looks different. Because a subdial is usually an independent display unit for displaying specific information, a design that does not appear odd to the user due to differences in color tone can be achieved even when a second transmittance area is in the area of the subdial and the tone of the subdial is different from the rest of the dial.

Furthermore, because the part of the dial not corresponding to the subdial is a first transmittance area, the part of the dial not superimposed in plan view with the power generating portion and the surrounding area superimposed with the power generating portion can be a first transmittance area. The appearance of the electronic timepiece can therefore be improved because the difference in tone between the power generating portion and the notch and non-power generating portion of the dial is difficult to discern.

An electronic timepiece according to another aspect preferably also has an opaque, light-blocking member disposed to the dial; the solar panel has multiple solar cells; a division line separating adjacent solar cells has a straight segment and a curved segment; and the curved segment is superimposed in plan view with the light-blocking member.

Thus comprised, curved segments of the division line that are more conspicuous than straight segments are hidden by the light-blocking member and not seen, and the appearance of the electronic timepiece can be improved.

In an electronic timepiece according to another aspect, the solar panel has multiple solar cells; a division line separating adjacent solar cells is superimposed in plan view with the first transmittance area; and a booster circuit boosts the output voltage of the solar panel.

Compared with a configuration not having a booster circuit, the number of solar cells can be reduced because the output voltage of the solar panel can be reduced to achieve the same voltage. As a result, the number of division lines can be reduced, and a second transmittance area can be easily disposed in the area of the dial not superimposed in plan view with the division lines.

Further preferably in an electronic timepiece according to another aspect, the antenna is disposed to a position not superimposed in plan view with the power generating portion.

As a result, the reception sensitivity of the antenna can be improved compared with a configuration in which part of the antenna is superimposed in plan view with the power generating portion.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 shows an example of an electronic timepiece according to a first embodiment.

FIG. 2 is a plan view of the electronic timepiece in the first embodiment.

FIG. 3 is a section view of the electronic timepiece in the first embodiment.

FIG. 4 is a plan view of the solar panel in the first embodiment.

FIG. 5 is a section view of the solar panel in the first embodiment.

FIG. 6 is a plan view of the dial in the first embodiment.

FIG. 7 is a circuit configuration of the electronic timepiece in the first embodiment.

FIG. 8 is a plan view of the solar panel in a second embodiment.

FIG. 9 is a plan view of the dial in a third embodiment.

FIG. 10 is a plan view of the dial in a fourth embodiment.

FIG. 11 is a plan view of the dial in another example.

FIG. 12 is a plan view of the dial in another example.

FIG. 13 is a plan view of the dial in another example.

### DESCRIPTION OF EMBODIMENTS

### Embodiment 1

A first embodiment is described below with reference to accompanying figures. Note that the crystal 15 side of the electronic timepiece 1 in the following embodiments is also referred to as the face, front, or top side, and the back cover 12 side is also referred to as the back or bottom side of the electronic timepiece 1.

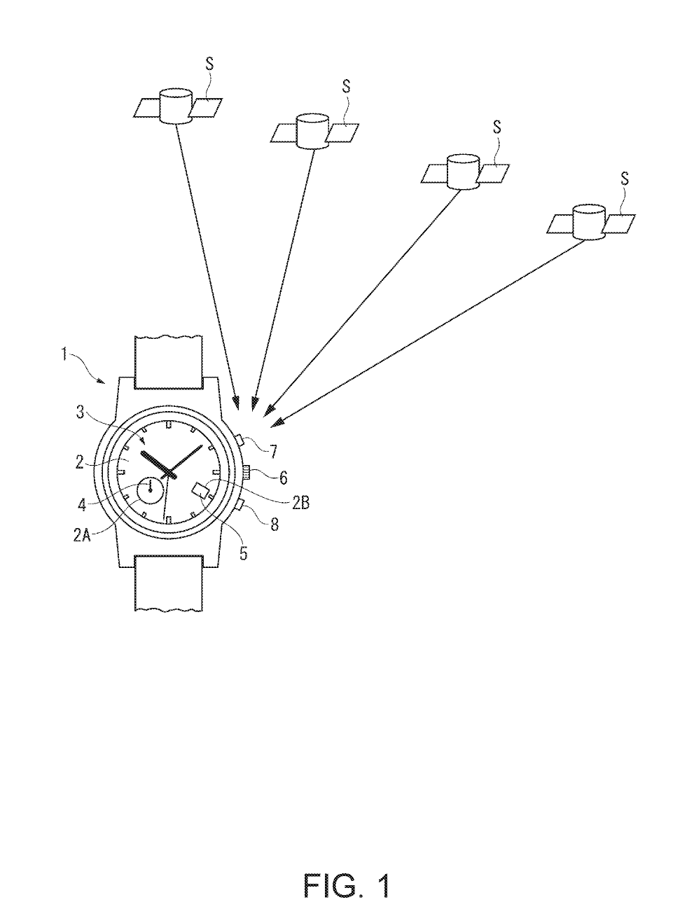

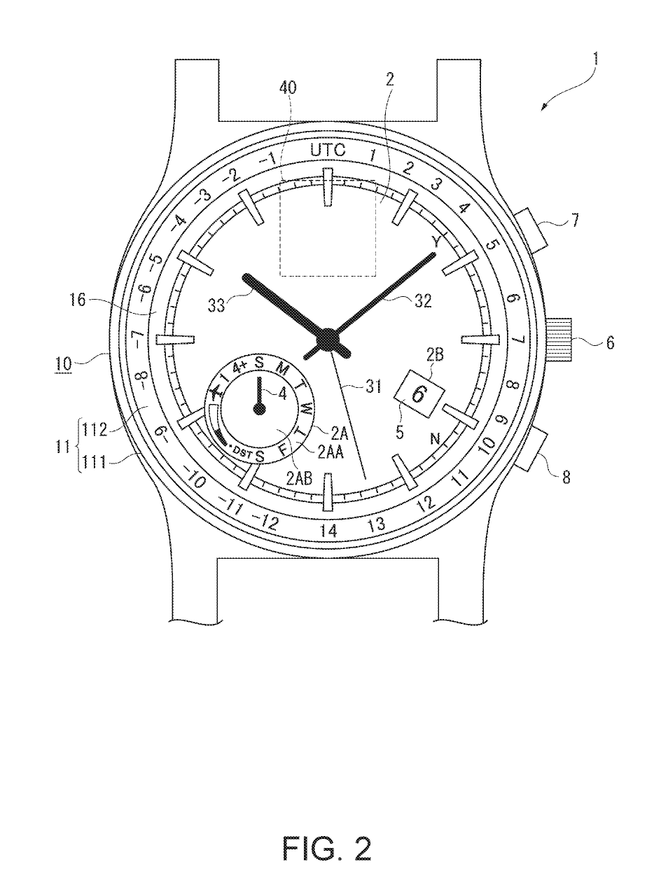

As shown in FIG. 1 and FIG. 2, the electronic timepiece 1 is a wristwatch with a time display unit for displaying the time using a dial 2 and hands 3, an information display unit including a subdial 2A of the dial 2 and a hand 4, and a calendar display unit including a window 2B in the dial 2 and a date wheel 5.

The dial 2 is a disc-shaped member made of an optically transparent, non-conductive material. Markers for displaying the time are disposed to the dial 2. A “Y” marker indicating that reception was successful is at the 8 second position on the dial 2, and a “N” marker indicating that reception failed is at the 22 second position.

A subdial 2A is disposed between 7:00 and 8:00 on the dial 2. The subdial 2A comprises a ring portion 2AA formed in a circle on the dial 2, and a disc portion 2AB, which is the part of the dial 2 surrounded by the ring portion 2AA in plan view. The ring portion 2AA is a decorative member made of metal or other opaque material.

The letters S, M, T, W, T, F, S indicating the days of the week are provided on the right side of the ring portion 2AA. A “DST” marker indicating the summer time (daylight saving time) mode is set, and a solid dot “.” marker indicating that DST is not set, are provided at 7:00 on the left side (7:00 from the pivot 4A of the hand 4) of the ring portion 2AA. A sickle-shaped scale between these markers, for indicating the current power reserve (remaining battery capacity) is provided from 8:00 to 9:00 on the ring portion 2AA. Between 9:00 and 12:00 on the ring portion 2AA are an airplane marker denoting an airplane mode, a “1” marker indicating that the timekeeping reception process is executing, and a “4+” marker indicating that the positioning reception process is executing. An information display unit embodied by the subdial 2A and hand (small hand) 4 thus displays information such as the day of the week, the reserve power, and operating mode information.

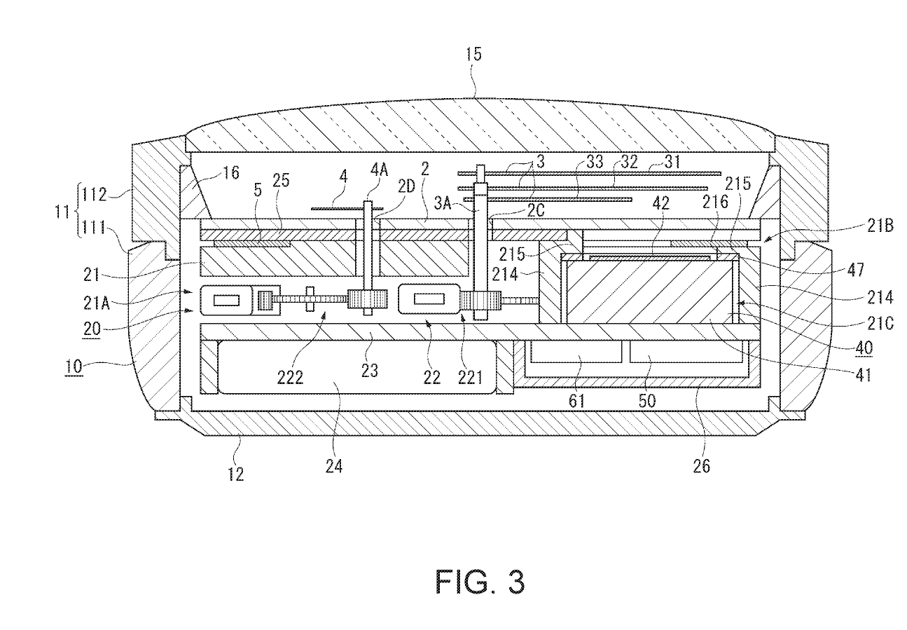

A calendar window 2B is located at 4:00 on the dial 2. In addition to the subdial 2A and window 2B, a through-hole 2C through which the center pivot 3A of the hands 3 passes, and a through-hole 2D through which the pivot 4A of the small hand 4 passes, are formed in the dial 2 as shown in FIG. 3.

FIG. 3 is a section view through a line extending from 12:00 to the through-hole 2C, and from the through-hole 2C to the midpoint between 7:00 and 8:00.

The hands 3 include a second hand 31, minute hand 32, and hour hand 33. The hands 3, 4 and date wheel 5 are driven by a drive mechanism including stepper motors and wheel train as described further below.

The electronic timepiece 1 also has a crown 6 and buttons 7 and 8.

The electronic timepiece 1 is configured to receive satellite signals and acquire satellite time information from plural positioning information satellites, such as GPS satellites, orbiting Earth on known orbits, acquire satellite time information, and correct internal time information based on the acquired satellite time information.

Note that the GPS satellites S shown in FIG. 1 are an example of a positioning information satellite, and multiple satellites are in orbit. At present, there is a constellation of approximately 30 GPS satellites in orbit.

External Structure of the Electronic Timepiece

As shown in FIG. 2 and FIG. 3, the electronic timepiece 1 has a case 10 that houses a movement 20 described further below. The case 10 includes the main case 11 and back cover 12.

The main case 11 includes a tubular case member 111, and a bezel 112 disposed on the front side of the case member 111.

The bezel 112 is ring-shaped. The bezel 112 and case member 111 are connected by an interlocking tongue-and-groove structure formed on their mutual opposing surfaces, or by double-sided adhesive tape or adhesive, for example. The bezel 112 may also be attached so that it can rotate on the outside case member 111.

The crystal 15 is attached to the inside of the bezel 112 and is held by the bezel 112.

A round back cover 12 is disposed to the back cover side of the outside case member 111 covering the back cover side opening to the outside case member 111. The back cover 12 and the outside case member 111 screw together.

Note that the outside case member 111 and the back cover 12 are discrete members in this embodiment, but the invention is not so limited and the outside case member 111 and back cover 12 may be formed in unison as a single piece.

The outside case member 111, bezel 112, and back cover 12 are made of brass, stainless steel, titanium alloy, or other conductive metal material.

Internal Configuration of the Electronic Timepiece

The internal structure housed in the case 10 of the electronic timepiece 1 is described next.

As shown in FIG. 2 and FIG. 3, a movement 20, planar antenna 40 (patch antenna), date wheel 5, and dial ring 16 are housed in addition to the dial 2 inside the case 10.

The movement 20 includes the base plate 21, a drive module 22 supported by the base plate 21, a circuit board 23, a storage battery 24, and a solar panel 25.

The base plate 21 is made from plastic or other non-conductive material. The base plate 21 includes a drive module housing 21A that holds the drive module 22, a date wheel housing 21B where the date wheel 5 is disposed, and an antenna housing 21C that holds the planar antenna 40.

The drive module housing 21A and antenna housing 21C are disposed on the back side of the base plate 21. The antenna housing 21C has four walls 214 (only two shown in FIG. 3) facing the four sides of the planar antenna 40, and four cover parts 215 (only two shown in FIG. 3) protruding from the walls 214 and opposing the front side of the planar antenna 40. A through-hole 216 overlapping at least part of the antenna electrode 42 of the planar antenna 40 in plan view is formed between the cover parts 215. Note that the four walls 214 are formed in unison, and the four cover parts 215 are formed in unison.

Because the antenna housing 21C is at 12:00 on the dial 2 in plan view, the planar antenna 40 is also located at 12:00 as shown in FIG. 2.

The drive module 22 is held in the drive module housing 21A of the base plate 21, and drives the time display unit, information display unit, and date display unit. More specifically, the drive module 22 includes a drive mechanism 221 with a stepper motor and wheel train for driving the hands 3, a drive mechanism 222 with a stepper motor and wheel train for driving the hand 4, and a drive mechanism 223 (not shown in the figure) including a stepper motor and wheel train for driving the date wheel 5.

The top side of the circuit board 23 contacts the back side of the base plate 21, and is attached to the base plate 21 by screw or other fastener. The planar antenna 40 is mounted on the face side of the circuit board 23. A reception module 50 (wireless communication unit) that processes satellite signals received from the GPS satellites S by the planar antenna 40, and a control unit 61 that controls the drive mechanisms 221, 222, are mounted on the back side of the circuit board 23.

The reception module 50 and control unit 61 are located on the opposite side of the circuit board 23 as the planar antenna 40. The reception module 50 and control unit 61 are also enclosed by a shield 26. As a result, signals received by the planar antenna 40 are protected from noise produced by the reception module 50 and control unit 61.

A lithium storage battery is used for the storage battery 24. The storage battery 24 supplies power to the drive module 22, reception module 50, and control unit 61. The storage battery 24 is also disposed to the back side of the circuit board 23 at a position not overlapping the reception module 50 and control unit 61 in plan view.

The date wheel 5, which is a ring-shaped calendar wheel having date numbers displayed on the surface, is held in the date wheel housing 21B of the base plate 21. The date wheel 5 is made from plastic or other non-conductive material. In plan view, the date wheel 5 overlaps at least part of the planar antenna 40. Note that the calendar wheel is not limited to a date wheel 5, and may be a day wheel showing the days of the week, or a month wheel showing the months.

Planar Antenna

The planar antenna 40 is disposed in the antenna housing 21C. The planar antenna 40 receives satellite signals from GPS satellites S.

GPS satellites S transmit right-hand circularly polarized satellite signals. As a result, the planar antenna 40 according to this embodiment is a patch antenna (also called a microstrip antenna) with excellent circular polarization characteristics.

The planar antenna 40 according to this embodiment is a patch antenna having a conductive antenna electrode 42 on a ceramic dielectric substrate 41.

This planar antenna 40 can be manufactured as described below. First, barium titanate with a dielectric constant of 60-100 is formed to the desired shape in a press and sintered to complete the ceramic dielectric substrate 41 of the antenna. A ground electrode forming the ground plane (GND) of the antenna is made by screen printing a primarily silver (Ag) paste, for example, on the back side (the side facing the circuit board 23) of the dielectric substrate 41.

An antenna electrode 42 that determines the antenna frequency and the polarity of the received signals is formed on the face side of the dielectric substrate 41 (the side facing the base plate 21 and dial 2) by the same method as the ground electrode 43. The antenna electrode 42 is slightly smaller than the surface of the dielectric substrate 41, and an exposed surface where the antenna electrode 42 is not present is disposed around the antenna electrode 42 on the surface of the dielectric substrate 41.

Solar Panel

The solar panel 25 is a photovoltaic device that converts light energy to electrical energy, and receives and converts light passing through the dial 2 to electrical energy.

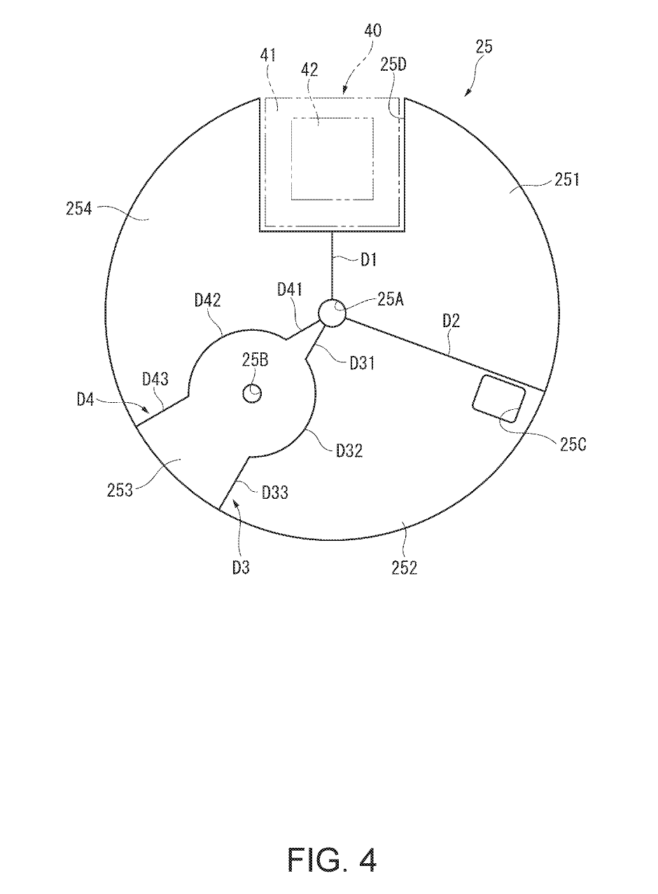

The solar panel 25 is disposed to the face side of the base plate 21. FIG. 4 is a plan view of the solar panel 25 from the face side. Note that the imaginary line in the figure indicates the planar antenna 40.

As shown in FIG. 4, the solar panel 25 is substantially round. A through-hole 25A through which the center pivot 3A of the hands 3 pass is formed in the plane center, a through-hole 25B through which the pivot 4A of the hand 4 passes is formed in the middle between 7:00 and 8:00 from the plane center, a through-hole 25C corresponding to the date window 2B is formed at 4:00, and a notch 25D superimposed with the planar antenna 40 in plan view planar antenna 40 is formed at 12:00.

Because GPS satellite signals are high frequency signals of approximately 1.5 GHz, GPS signals are attenuated by even the thin transparent electrode of the solar panel, unlike the long wave standard time signals received by radio-controlled timepieces, and antenna performance drops. As a result, a notch 25D is formed in the disc-shaped solar panel 25 in the area overlapping the antenna electrode 42 and dielectric substrate 41 of the planar antenna 40 in plan view. The solar panel 25 therefore covers the face side of the base plate 21 but does not cover the face side of the planar antenna 40. The planar antenna 40 can therefore receive radio waves through the notch 25D in the solar panel 25.

The solar panel 25 is segmented into four solar cells 251-254 by four division lines D1-D4 extending from the through-hole 25A to the outside circumference. The four solar cells 251-254 are the generating portions of the solar panel 25, and are connected in series by connectors not shown.

The solar cell 251 is segmented by a division line D1 extending from the through-hole 25A toward 12:00 to the notch 25D, and a division line D2 extending from the through-hole 25A to 4:00, into adjacent solar cells 254, 252. Division lines D1 and D2 are straight lines.

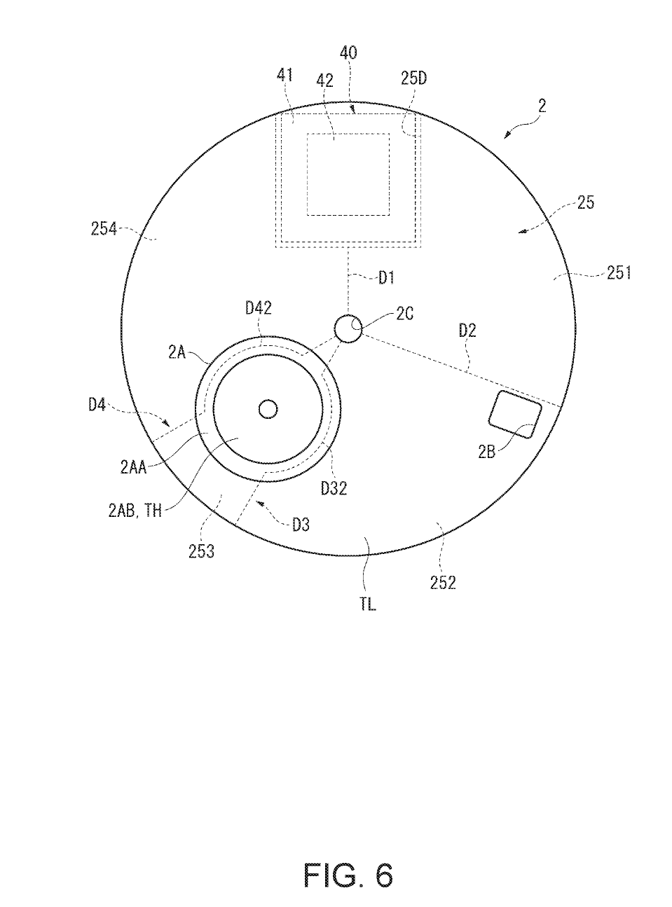

The solar cell 251 is also segmented by division line D2 and a division line D3 extending from the through-hole 25A to 7:00, into adjacent solar cells 251, 253. Division line D3 includes a straight segment D31, a curved segment D32 superimposed in plan view with the ring portion 2AA (FIG. 6) and following the curve of the ring portion 2AA, and a straight segment D33.

Through-hole 25C is formed in solar cell 252.

Solar cell 253 is separated from the adjacent solar cells 252, 254 by division line D3 and a division line D4 from the through-hole 25A to 8:00. This division line D4 includes a straight segment D41, a curved segment D42 superimposed in plan view with the ring portion 2AA and following the curve of the ring portion 2AA, and a straight segment D43.

Through-hole 25B is formed in solar cell 253.

Solar cell 254 is separated from the adjacent solar cells 253, 251 by division line D4 and division line D1.

Because the solar cells 251-254 are connected in series, the current output of the solar panel 25 is limited to the output of the solar cells 251-254 with the lowest current output. To maximize the current output of the solar panel 25, the current output of the solar cells 251-254 is preferably as uniform as possible.

The current output of the solar cells 251-254 is proportional to the area exposed to (receiving) light and the irradiance at the cell surface. Because light reaches the solar cells after passing through the dial 2, the irradiance changes with the transmittance of the dial 2. Because the dial 2 has a low transmittance area TL and a high transmittance area TH of differing transmittance as described below, transmittance differs in the areas of the dial 2 corresponding to the solar cells 251-254. As a result, the area of the solar cell is increased where the transmittance of the corresponding area of the dial 2 is low, and the area of the solar cell is decreased where the transmittance of the corresponding area of the dial 2 is high. As a result, the product of the exposed area of the solar cells 251-254 and the transmittance of the dial 2 where the light received by the solar cells 251-254 passes can be equalized, and the current output of the solar cells 251-254 can be equalized.

Note that when the area of the dial 2 corresponding to a solar cell has both a low transmittance area TL and a high transmittance area TH, this product is obtained by adding the product of the exposed area in the low transmittance area TL and the transmittance of the low transmittance area TL, and the product of the exposed area in the high transmittance area TH and the transmittance of the high transmittance area TH.

That the output of the solar cells 251-254 is equal includes being substantially the same, such as the output of each solar cell 251-254 being within +/−10% of the average output of all solar cells 251-254.

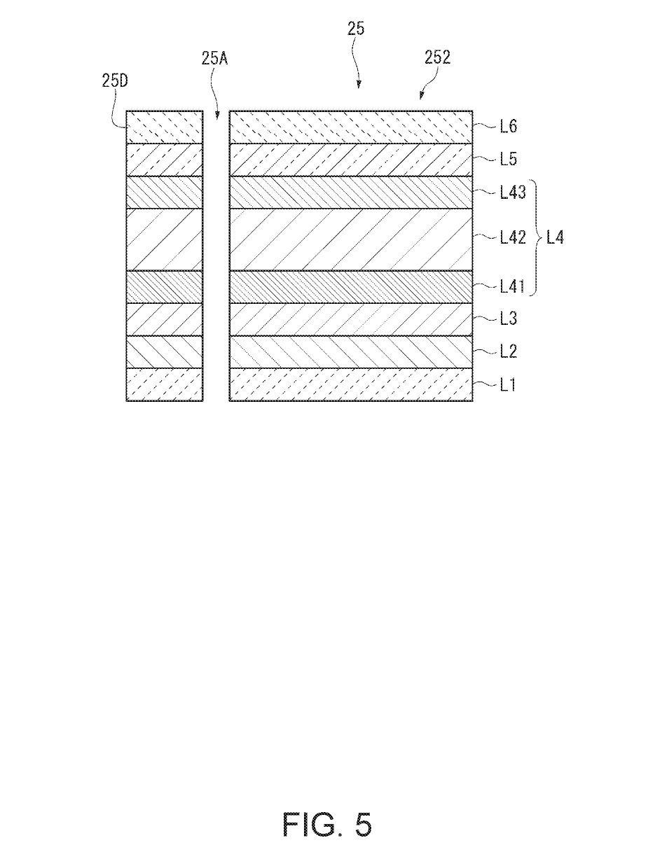

FIG. 5 is a section view of the solar panel 25 on a line between 12:00 and 6:00.

As shown in FIG. 5, the solar panel 25 has a metal electrode L3, amorphous silicon L4, transparent electrode L5, and protective film L6 formed in layers on the surface of a plastic film substrate L2 having another protective film L1 formed on the back side thereof.

The amorphous silicon L4 layer is a sandwich of an i-type semiconductor L42 between an n-type semiconductor L41 and a p-type semiconductor L43.

When light that past through the protective film L6 and transparent electrode L5 is incident to the surface of the amorphous silicon L4, electrons and holes are produced in the i-type semiconductor L42 by light energy. The resulting electrons and holes move toward the p-type semiconductor L43 and n-type semiconductor L41, respectively. As a result, current flows to the external circuit connected to the transparent electrode L5 and metal electrode L3. The solar panel 25 thus produces power by photovoltaic conversion.

Dial

The dial 2 is disposed on the face side of the base plate 21 and covering the solar panel 25 and date wheel 5. The dial 2 is made from polycarbonate or other material that is non-conductive and transparent to at least some light.

FIG. 6 is a plan view of the dial 2 from the face side. The imaginary lines indicate the solar panel 25 and planar antenna 40 that are covered by the dial 2.

As shown in FIG. 6, the dial 2 has a high transmittance area TH in the disc portion 2AB corresponding to the subdial 2A, and the part of the dial 2 outside the disc portion 2AB is a low transmittance area TL.

The low transmittance area TL is an example of a first transmittance area with specific transmittance, and the high transmittance area TH is an example of a second transmittance area with higher transmittance than the first transmittance area.

The low transmittance area TL has low transmittance (such as 26%) so that it is difficult to see through the face side of the dial 2 to the back side of the dial 2. The low transmittance area TL is thus a visibility suppression area that reduces the ability to see the back cover side of the dial 2.

Because the notch 25D and division lines D1-D4 of the solar panel 25 are superimposed in plan view with the low transmittance area TL, they are difficult to see.

The high transmittance area TH has higher transmittance than the low transmittance area TL, allows more light to pass through the dial 2, and has transmittance (such as 95%) that can improve the output of the solar panel 25. In other words, the high transmittance area TH contributes to generating power.

Because the high transmittance area TH is superimposed in plan view with the solar panel 25, all light passing through the high transmittance area TH is incident to the solar panel 25.

The curved segment D32 of the division line D3, and the curved segment D42 of the division line D4, are superimposed in plan view with the ring portion 2AA of the subdial 2A. In other words, because the ring portion 2AA is opaque, the curved segments D32, D42 are not visible from the face side of the dial 2.

As shown in FIG. 2 and FIG. 3, a dial ring 16 that is made of a non-conductive plastic material in a ring shape is disposed to the face side of the dial 2. The dial ring 16 is disposed around the circumference of the dial 2, is conically shaped with the inside circumference surface sloping down to the dial 2, and has 60 minute markers printed on the inside sloping surface. The dial ring 16 is held pressed against the dial 2 by the bezel 112.

In the electronic timepiece 1 according to this embodiment, the antenna electrode 42 of the planar antenna 40 is not superimposed in plan view with the main case 11 (outside case member 111 and bezel 112) or solar panel 25, but does overlap the date wheel 5, dial 2, and crystal 15, which are made from non-conductive materials. More specifically, all parts of the electronic timepiece 1 that are over the face side of the planar antenna 40 in plan view are made from non-conductive materials.

As a result, satellite signals passing from the face side of the timepiece pass through the crystal 15, and then pass through the dial 2 and date wheel 5 and are incident to the antenna electrode 42 without interference from the main case 11 or solar panel 25. Note that because area of the hands 3, 4 over the planar antenna 40 is small, there is no interference with signal reception even if the hands are metal, but the hands are preferably made from a non-conductive material because any interference with signal reception can be avoided.

Circuit Configuration of the Electronic Timepiece

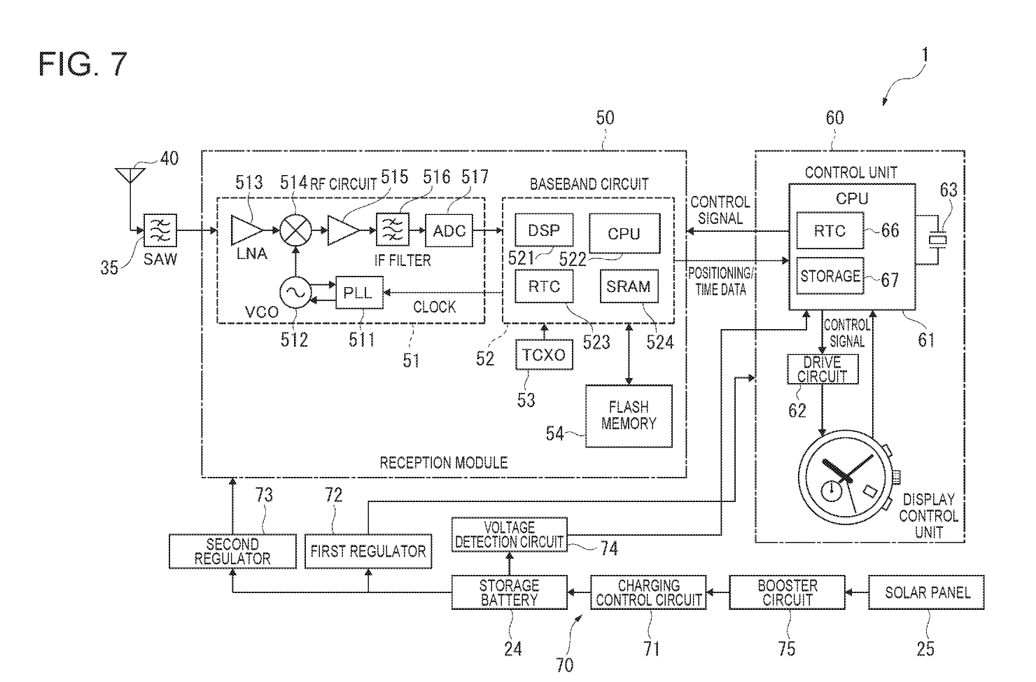

The circuit configuration of the electronic timepiece 1 is described next with reference to FIG. 7.

As shown in FIG. 7, the electronic timepiece 1 has a planar antenna 40, a SAW filter 35, the reception module 50, a display control unit 60, and a power supply unit 70.

The SAW filter 35 is a bandpass filter that passes signals in the 1.5 GHz waveband. A LNA (low noise amplifier) may also be disposed between the planar antenna 40 and the SAW filter 35 to improve reception sensitivity.

Note also that the SAW filter 35 may be embedded in the reception module 50.

The reception module 50 processes satellite signals passed through the SAW filter 35, and includes an RF (radio frequency) circuit 51 and a baseband circuit 52.

The RF circuit 51 includes a PLL (phase-locked loop) circuit 511, a VCO (voltage controlled oscillator) 512, a LNA (low noise amplifier) 513, a mixer 514, an IF (intermediate frequency) amplifier 515, an IF filter 516, and an A/D converter 517.

The satellite signal passed by the SAW filter 35 is amplified by the LNA 513, mixed by the mixer 514 with the clock signal output by the VCO 512, and down-converted to a signal in the intermediate frequency band.

The IF signal from the mixer 514 is amplified by the IF amplifier 515, passed through the IF filter 516, and converted to a digital signal by the A/D converter 517.

The baseband circuit 52 includes, for example, a DSP (digital signal processor) 521, CPU (central processing unit) 522, a RTC (real-time clock) 523, and SRAM (static random access memory) 524. A TCXO (temperature compensated crystal oscillator) 53 and flash memory 54 are also connected to the baseband circuit 52.

A digital signal is input from the A/D converter 517 of the RF circuit 51 to the baseband circuit 52, which acquires satellite time information and navigation information by a correlation process and positioning computation process.

Note that the clock signal for the PLL circuit 511 is generated by the TCXO 53.

A time difference database relationally storing location information (latitude and longitude data) and time difference data is stored in flash memory 54. Note that an EEPROM (Electrically Erasable Programmable Read-Only Memory) device may be used instead of flash memory 54.

The time difference database is stored in flash memory 54 in the reception module 50 in this embodiment, but nonvolatile memory such as EEPROM or flash memory may be provided in the control unit 61 of the display control unit 60 and the time difference database stored in this nonvolatile memory.

The display control unit 60 includes a control unit (CPU) 61, a drive circuit 62 that drives the hands 3, 4, a crystal oscillator 63, a time display unit, and an information display unit.

The control unit 61 includes a RTC 66 and storage 67.

The RTC 66 calculates the internal time information using a reference signal output from the crystal oscillator 63.

The storage 67 stores the satellite time information and positioning information output from the reception module 50.

By having the reception module 50 and display control unit 60 described above, the electronic timepiece 1 in this example can automatically correct the displayed time based on the satellite signals received from the GPS satellites S.

The power supply unit 70 includes the solar panel 25, a booster circuit 75, a charging control circuit 71, the storage battery 24, a first regulator 72, a second regulator 73, and a voltage detection circuit 74.

When light is incident to the solar panel 25, the booster circuit 75 boosts the output voltage of the solar panel 25 by twice, for example. The booster circuit 75 is a charge pump booster, for example.

The charging control circuit 71 supplies the power boosted by the booster circuit 75 to the storage battery 24 and charges the storage battery 24.

The storage battery 24 embodies the power supply, and supplies drive power through the first regulator 72 to the display control unit 60, and supplies power through the second regulator 73 to the reception module 50.

The voltage detection circuit 74 monitors the output voltage of the storage battery 24, and outputs to the control unit 61. Because the battery voltage detected by the voltage detection circuit 74 is input to the control unit 61, the control unit 61 can know the storage battery 24 voltage and control the reception process accordingly.

### Effect of Embodiment 1

Because the notch 25D and division lines D1-D4 are superimposed in plan view with the low transmittance area TL, they are difficult to see and the appearance of the electronic timepiece 1 can be improved.

Furthermore, by having a high transmittance area TH, the amount of light reaching the solar panel 25 can be increased and the power generating performance of the solar panel 25 can be improved compared with a configuration in which all of the dial 2 is a low transmittance area TL.

The tone of the low transmittance area TL and high transmittance area TH look different because of the different transmittance. Because the subdial 2A is an independent display unit that can display specific information, a design that does not appear odd to the user due to the different tone can be achieved even when a high transmittance area TH is in the area of the subdial 2A and the tone of the subdial 2A is different from the rest of the dial 2.

Because the part of the dial 2 outside of the subdial 2A is a low transmittance area TL, the notch 25D and the surrounding portion of the solar panel 25 are superimposed in plan view with the low transmittance area TL. As a result, it is difficult to discern a difference in tone between the notch 25D and solar panel 25, and the appearance can be improved.

The appearance of the electronic timepiece 1 can also be improved because the curved segments D32, D42 of the division lines, which are more conspicuous than the straight segments, are hidden by the ring portion 2AA and cannot be seen.

The current output of the solar panel 25 can also be maximized because the power output of the solar cells 251-254 can be equalized.

By having a booster circuit 75, fewer solar cells are needed than when a booster circuit 75 is not used because the same voltage can be achieved with a lower output voltage from the solar panel 25. As a result, the number of division lines can also be reduced, and a high transmittance area TH can be easily formed in the dial 2 in an area not superimposed in plan view with division lines.

### Embodiment 2

The solar panel 25 in the first embodiment is disposed to a position not superimposed in plan view with the planar antenna 40, but the solar panel in a second embodiment is also disposed superimposed with the planar antenna 40. However, the metal electrode L3, amorphous silicon L4, and transparent electrode L5 are not formed in the part of the solar panel superimposed with the planar antenna 40, and this part of the solar panel does not function to generate power.

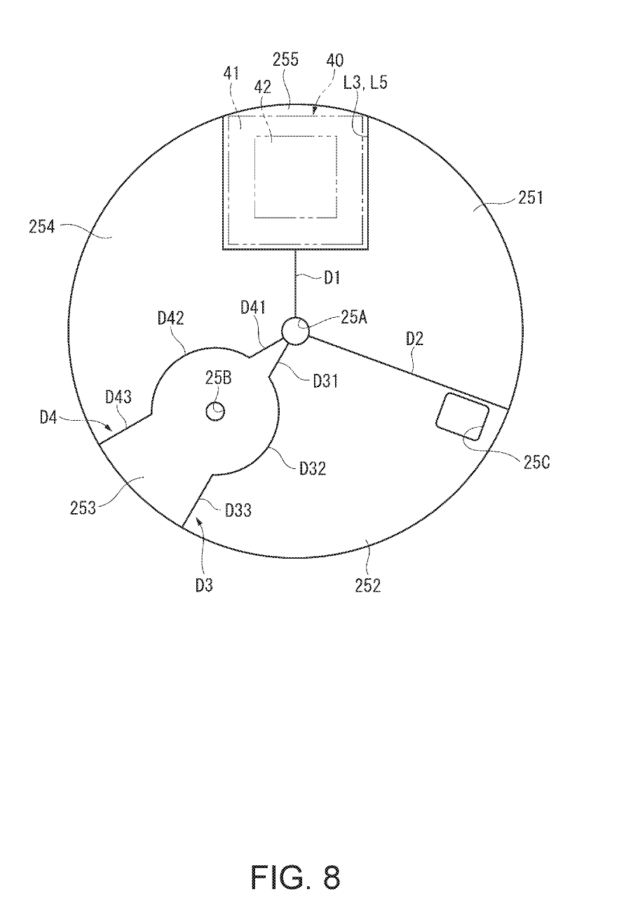

FIG. 8 is a plan view of the solar panel in this second embodiment from the face side. Note that the imaginary line in the figure indicates the planar antenna 40.

As shown in FIG. 8, the solar panel in this embodiment is also formed in the area superimposed in plan view with the planar antenna 40, but the metal electrode L3, amorphous silicon L4, and transparent electrode L5 are not formed in this part. More specifically, the protective film L1, plastic film substrate L2 and protective film L6 are formed in this part. In other words, only members that are non-conductive and do not block signal transmission are formed in this part.

The planar antenna 40 can therefore receive signals through the solar panel 25. Note that this part is a non-generating portion 255 that does not function to generate power.

Other aspects of the configuration of this electronic timepiece are the same as the electronic timepiece 1 in the first embodiment.

### Effect of Embodiment 2

The second embodiment is otherwise configured identically to the first embodiment, and has the same effect.

More specifically, the non-generating portion 255 is configured differently from the solar cells 251-254 and has a different tone, but because the non-generating portion 255 is superimposed in plan view with the low transmittance area TL and is difficult to see, the appearance of the electronic timepiece can be improved.

### Embodiment 3

An electronic timepiece according to the third embodiment differs from the first embodiment primarily in the plane shape of the solar cells of the solar panel and the presence of two subdials on the dial.

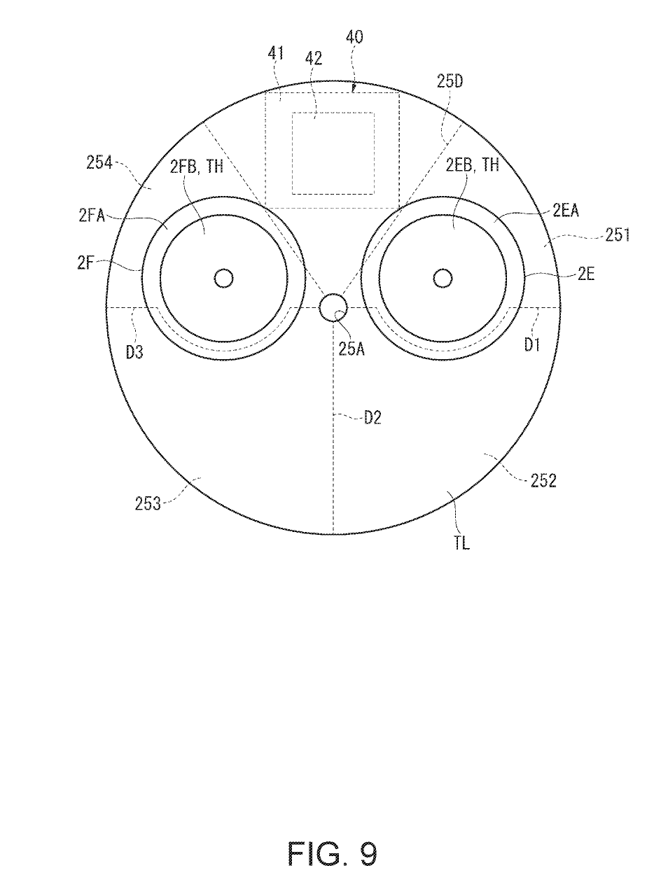

FIG. 9 is a plan view of the solar panel in this third embodiment from the face side. Note that the imaginary lines in the figure indicate the solar panel and planar antenna 40 hidden by the dial.

This embodiment has a subdial 2E at approximately 3:00 and another subdial 2F at approximately 9:00 on the dial.

Subdial 2E comprises a ring portion 2EA formed in a circle on the dial, and a disc portion 2EB, which is the part of the dial surrounded by the ring portion 2EA in plan view.

Subdial 2F comprises a ring portion 2FA formed in a circle on the dial, and a disc portion 2FB, which is the part of the dial surrounded by the ring portion 2FA in plan view.

The ring portion 2EA, 2FA are decorative members made of metal or other opaque material.

In this embodiment, the dial has a high transmittance area TH in the disc portions 2EB, 2FB, and the part of the dial outside the disc portions 2EB, 2FB is a low transmittance area TL. A date window is not disposed to the dial in this embodiment.

A fan-shaped notch 25D centered on the through-hole 25A in plan view is formed in the solar panel at 12:00.

The solar panel is segmented into four solar cells 251-254 by three division lines D1-D3.

Division line D1 goes from the through-hole 25A to 3:00, and includes a curved segment superimposed in plan view with the ring portion 2EA and following the curve of the ring portion 2EA, and straight segments.

Division line D2 is a straight line from the through-hole 25A to 6:00.

Division line D3 goes from the through-hole 25A to 6:00, and includes a curved segment superimposed in plan view with the ring portion 2FA and following the curve of the ring portion 2FA, and straight segments.

In this embodiment, the notch 25D and division lines D1-D3 of the solar panel are superimposed in plan view with the low transmittance area TL.

The curved segments of the division lines D1-D3 are superimposed in plan view with the ring portions 2EA, 2FA.

The product of the exposed area and the transmittance of the areas of the dial corresponding to the solar cells 251-254 is substantially equal in each of the solar cells 251-254.

Other aspects of this configuration are the same as the electronic timepiece 1 in the first embodiment.

### Effect of Embodiment 3

The third embodiment is basically configured identically to the first embodiment, and has the same effect.

More specifically, the notch 25D and division lines D1-D3 of the solar panel are difficult to see because they are superimposed in plan view with the low transmittance area TL.

The curved segments of the division lines D1-D3 are also hidden by the ring portions 2EA, 2FA, and are not seen.

The current output of the solar panel can also be maximized because the power output of the solar cells 251-254 can be equalized.

### Embodiment 4

Two subdials 2E, 2F are disposed to the dial of the third embodiment, but three subdials are disposed to the dial in this fourth embodiment.

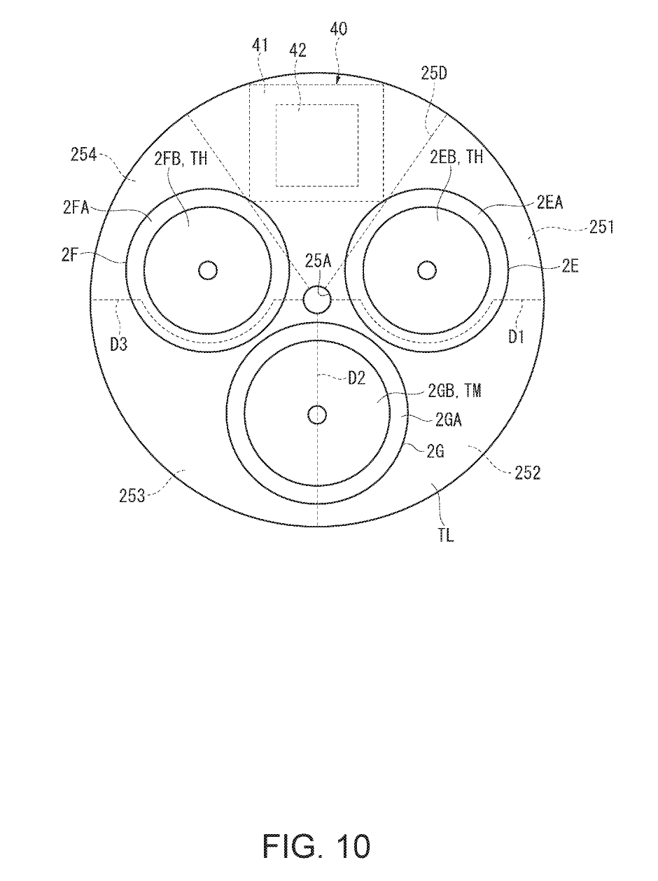

FIG. 10 is a plan view of the solar panel in this fourth embodiment from the face side. Note that the imaginary lines in the figure indicate the solar panel and planar antenna 40 hidden by the dial.

In addition to subdials 2E, 2F, the dial in this embodiment has a subdial 2G disposed to the dial at 6:00.

Subdial 2G comprises a ring portion 2GA formed in a circle on the dial, and a disc portion 2GB, which is the part of the dial surrounded by the ring portion 2GA in plan view. The ring portion 2GA is a decorative member made of metal or other opaque material.

The disc portion 2GB in this embodiment is a medium transmittance area TM. The medium transmittance area TM contributes to generating power, and is an example of a second transmittance area.

The transmittance of the medium transmittance area TM is greater than the transmittance of the low transmittance area TL, passes much light through the dial 2, and improves the power output of the solar panel; and has lower transmittance than the high transmittance area TH, and makes the back cover side of the dial more difficult to see than the high transmittance area TH.

The transmittance of the medium transmittance area TM is set to transmittance level (such as 50%) between the low transmittance area TL and the high transmittance area TH.

The medium transmittance area TM in this embodiment is superimposed in plan view with division line D2, which is straight. The division line D2 also passes through the plane center of the medium transmittance area TM.

Other aspects of the configuration are the same as the electronic timepiece of the third embodiment.

### Effect of Embodiment 4

The third embodiment is otherwise configured identically to the third embodiment, and has the same effect.

Straight segments of the division lines are less conspicuous than curved segments when seen through the dial. As a result, even when locating the high transmittance area TH and medium transmittance area TM, which contribute to generating power, at a position not superimposed in plan view with a division line is difficult and the power generating portion is superimposed with a division line, by locating the power generating portion (medium transmittance area TM) over a straight segment of the division line, the division line can be made difficult to see and the appearance of the electronic timepiece can be improved.

Furthermore, because the division line D2 superimposed with the medium transmittance area TM follows a straight line through the center of the dial and passes through the plane center of the medium transmittance area TM, the line is inconspicuous to the user.

Furthermore, because the medium transmittance area TM overlaps a division line and the high transmittance area TH does not overlap a division line, the division lines are more difficult to see than in the opposite case, that is, if the medium transmittance area TM does not overlap a division line and the high transmittance area TH overlaps a division line.

### Other Embodiments

The invention is not limited to the embodiments described above, and can be modified and improved in many ways without departing from the scope of the accompanying claims.

The planar antenna 40 is located at 12:00 in the foregoing embodiments, but the invention is not so limited and the planar antenna 40 may be placed in a different location.

The subdial 2A in the first embodiment is between 7:00 and 8:00, but the invention is not so limited and the subdial 2A may be placed in a different location.

A date window is provided at 4:00 on the dial in the first embodiment, but the invention is not so limited and the subdial 2A may be located at 3:00 or other position, or omitted.

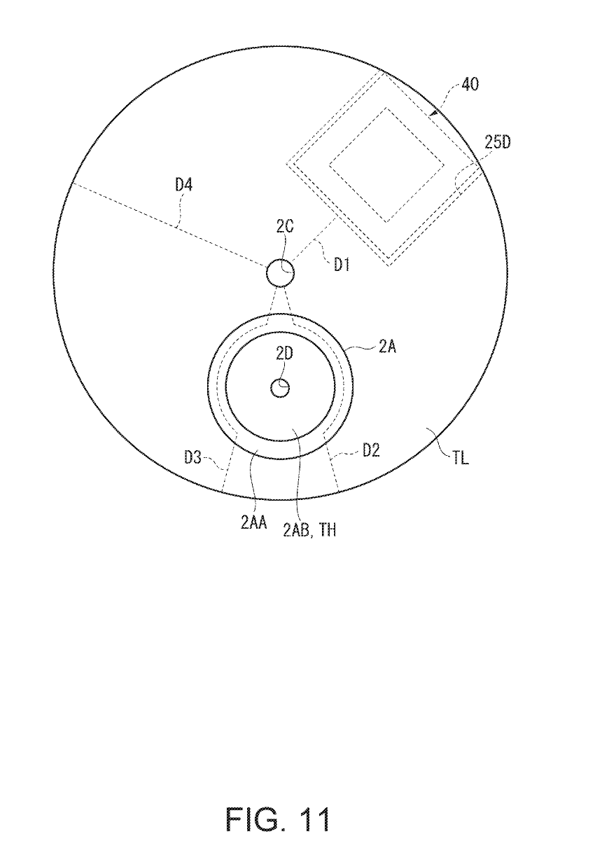

FIG. 11 shows a variation of the first embodiment. As shown in FIG. 11, the planar antenna 40 may be placed between 2:00 and 3:00, the subdial 2A at 6:00, and the date window omitted.

The subdials in the foregoing embodiments are round in plan view, but the invention is not so limited and may be shaped differently.

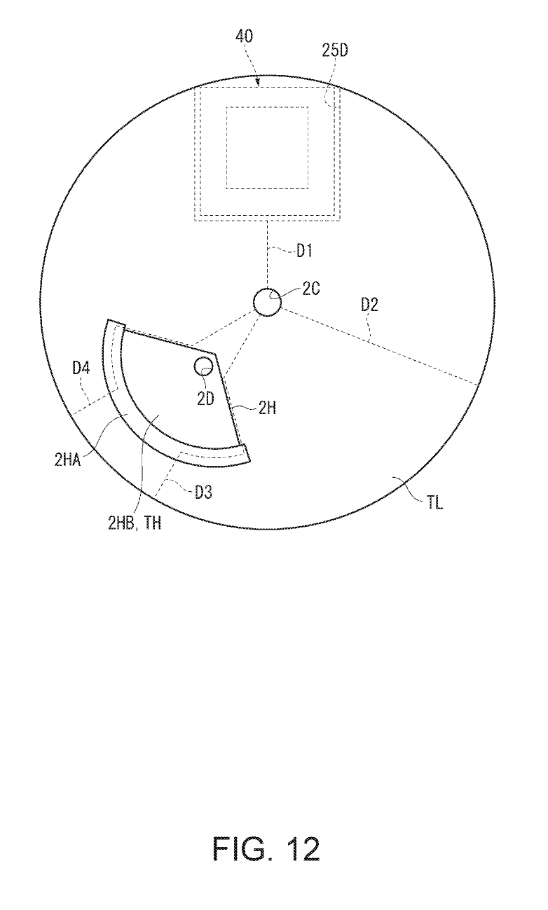

FIG. 12 shows a variation of the first embodiment. In the example shown in FIG. 12, a subdial 2H may be configured with a fan-shaped portion 2HB, which is a fan-shaped portion of the dial in plan view, and an arc 2HA disposed to the dial as a decorative member following the curve of the arc on the outside of the curve of the fan-shaped portion 2HB.

The subdial may also be configured without a ring, curved, or other decorative member.

In the example in FIG. 12, parts of division lines D3 and D4 are disposed along the border between the high transmittance area TH (second transmittance area) of the fan-shaped portion 2HB, and the low transmittance area TL (first transmittance area). This makes the division lines less conspicuous.

The solar panels in the foregoing embodiments comprise four solar cells, but the invention is not so limited. More specifically, the solar panel may have 1, 3, or 5 or more solar cells.

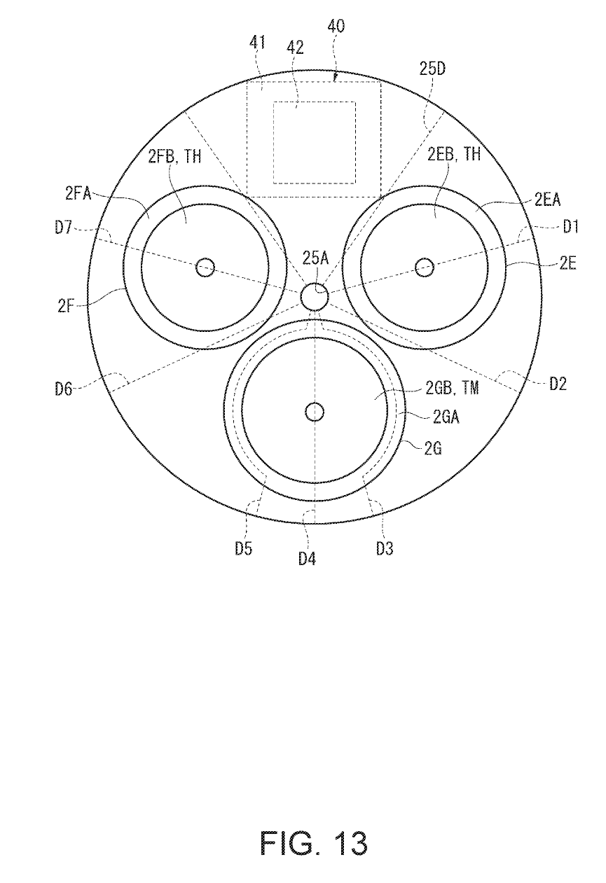

FIG. 13 shows a variation of the fourth embodiment. As shown in FIG. 13, the solar panel may be segmented into eight solar cells by division lines D1-D7. In this example, the medium transmittance area TM is superimposed in plan view with the division line D4, and two high transmittance areas TH are superimposed in plan view with division lines D1 and D7. Because the medium transmittance area TM and high transmittance area TH are superimposed with the straight segments of the division lines, the division lines are less conspicuous than when superimposed with the curved segments.

The power generating part of the solar panels in the foregoing embodiments are not superimposed in plan view with the planar antenna 40, but the invention is not so limited. More specifically, the power generating part may be superimposed with part of the dielectric substrate 41 or part of the antenna electrode 42 insofar as the planar antenna 40 can receive signals. The area of the power generating part can therefore be increased. However, the reception sensitivity of the planar antenna 40 can be improved if the power generating part does not overlap the dielectric substrate 41 and antenna electrode 42.

The product of the exposed area of the solar cells and the transmittance of the dial in the area where the light received by the solar cells passes is the same for each solar cell in the foregoing embodiments, but the invention is not so limited and the products may be unequal.

The high transmittance area TH and medium transmittance area TM in the foregoing embodiments are areas of the dial corresponding to the subdials, but the invention is not so limited and they may be areas of the dial outside of the subdials.

The invention can also be applied to an electronic timepiece without a subdial.

The curved segments of the division lines in the solar panel are superimposed in plan view with the ring of the subdial in the foregoing embodiments, but the invention is not so limited. For example, the curved segments may be superimposed with other opaque, light-blocking members on the dial. They may also be disposed not superimposed with light-blocking members.

The booster circuit 75 in the foregoing embodiments is a charge pump booster, but the invention is not so limited. A chopper circuit may be used instead, for example.

The gain of the booster circuit 75 is not limited to twice, and may be set to a different multiple.

The booster circuit 75 may also be omitted. In this event, EMF can be increased by increasing the number of solar cells to eight, for example.

The plane shape of the notch or non-conductive part of the solar panel in the foregoing embodiments is rectangular or fan-shaped, but the invention is not so limited and may be desirably shaped.

The non-generating part of the solar panel in the second embodiment comprises the protective film L1, plastic film substrate L2, and protective film L6, but the invention is not so limited. More specifically, any configuration that does not function to generate power and passes radio signals may be used.

The reception module in the foregoing embodiments receives satellite signals, but the invention is not so limited. For example, the reception module may be configured to receive microwave signals used for near-field communication, such as Bluetooth™ signals.

The transmittance of the low transmittance area TL, high transmittance area TH, and medium transmittance area TM in the foregoing embodiments is set to 26%, 95%, 50%, but the invention is not so limited and the transmittance may be desirably set.

For example, if the transmittance of the low transmittance area TL is 35% or less, the notch in the solar panel and non-conductive parts are difficult to see, but lower transmittance is preferable in terms of appearance.

The transmittance of the high transmittance area TH may also be close to 100% when the high transmittance area TH is not superimposed in plan view with a division line.

The transmittance of the medium transmittance area TM may be set desirably with consideration for the balance between power output and appearance.

The information displayed by the subdials in the foregoing embodiments is not limited to the day of the week, reserve power, or operating mode, and may be chronograph time, the time of a dual time function, or an alarm time.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

The entire disclosure of Japanese Patent Application No. 2015-157307, filed Aug. 7, 2015 is expressly incorporated by reference herein.

What is claimed is:

1. An electronic timepiece comprising:
an dial configured to transmit light;
a solar panel disposed on the back cover side of the dial and having a power generating portion; and
an antenna disposed on the back cover side of the dial and located at a position with at least part of the antenna not superimposed in plan view with the power generating portion;
the dial having a first transmittance area having a specific transmittance, and a second transmittance area having greater transmittance than the first transmittance area, and
the area of the dial not superimposed in plan view with the power generating portion being the first transmittance area.

2. The electronic timepiece described in claim 1, wherein:
the solar panel has multiple solar cells; and
a division line separating adjacent solar cells of the solar panel is superimposed in plan view with the first transmittance area.

3. The electronic timepiece described in claim 1, wherein:
the solar panel has multiple solar cells;
a division line separating adjacent solar cells of the solar panel has a straight segment; and
the second transmittance area is superimposed in plan view with the straight segment.

4. The electronic timepiece described in claim 1, wherein:
the solar panel has multiple solar cells; and
the product of the exposed area of the solar cell and the transmittance of the dial in the area corresponding to the solar cell is the same in each solar cell.

5. The electronic timepiece described in claim 1, wherein:
a subdial is disposed to the dial; and
the second transmittance area is disposed in the area corresponding to the subdial.

6. The electronic timepiece described in claim 1, wherein:
an opaque, light-blocking member is disposed to the dial;
the solar panel has multiple solar cells;
a division line separating adjacent solar cells has a straight segment and a curved segment; and
the curved segment is superimposed in plan view with the light-blocking member.

7. The electronic timepiece described in claim 1, wherein:
the solar panel has multiple solar cells;
a division line separating adjacent solar cells is superimposed in plan view with the first transmittance area; and
a booster circuit boosts the output voltage of the solar panel.

8. The electronic timepiece described in claim 1, wherein:
the antenna is disposed to a position not superimposed in plan view with the power generating portion.
